(19) United States
(12) Patent Application Publication
(10) Pub. No.: US 2005/0099262 A1
(43) Pub. Date: May 12, 2005

(54) Electronic wireless locking system

(76) Inventors: Robert Ney Childress, Chandler, AZ (US); Greg S. Clark, Phoenix, AZ (US)

Correspondence Address: LAW OFFICES OF DOUGLAS W RUDY LLC;14614 NORTH KIERLAND BLVD, SUITE 300, SCOTTSDALE, AZ, 85254, US

(21) Appl. No.: 10/703,725

(22) Filed: Nov. 7, 2003

(51) Int. Cl. G05B 19/00

(52) U.S. Cl. 340/5.6

(57) ABSTRACT

This invention pertains to the use of a cellular telephone to control a locking module. The locking module is used in controlling access to a secured location, a vehicle, or through a door, or other structure or situation where access is or may be controlled by use of a locking device. Cellular telephone communication links are used to communicate between a base station and a remote lock module such that activity at the remote location is controlled by the base station. Variations and methods with different advantageous features are also described.

### BACKGROUND OF THE INVENTION

This invention relates to the use of a standard cellular telephone link to provide communications to and from a base station and a remote locking module. The locking module may be used as a mechanism that prevents access to a conventional lock assembly, controls access to a secured location, building, structure, outpost, lockup, chamber, passage or access port, fenced or walled area, lockbox, vehicle, vessel, aircraft, or through a door, gate, window, lid, drawer, or any other structure or situation where access is or may be controlled by use of a lock, latch, keyed, coded or triggerable locking device or the like.

Access to secured locations is often controlled by use of locks that prevent the opening of access ports, doors or gates. The locks are usually keyed or combination-controlled locks where the lock will only opens when the proper key or combination is used. Coded locks, where a key code is input to a control module and the control module signals or triggers the opening or dosing of the lock are also known.

It is necessary for a person interested in accessing a locked zone to have the key, combination or code with him when he wants to enter a particular access controlled zone. As an example, building maintenance and security personnel often have rings of keys that they carry with them to open various locks. Even in situations where so called “master keys” are available to maintenance, security and management personnel, these people still need numerous different keys to open all the different types of locks on a particular property or in a particular environment. For instance, in a hotel environment a single master key may open all the conference rooms and all the guest rooms but that master key may not open the gates to storage areas, storage rooms secured with pad locks, the hotel's safe, other outbuildings, the vehicles used in support of the hotel, locked electrical panels, computer room hardware panels and other locked or lockable structures, passageways or secured areas.

A related problem is that of emergency people needing access to a facility. Fire and police will not let a lock stop them from making a rescue or attacking a burning building, they will break down the barrier before wasting time trying to open a lock. Therefore, a locking system that can be opened by cell phone communication is a system that will appeal to police, fire, paramedics, and ambulance personnel as they can access the base station and get instant access to a secured facility after properly identifying themselves.

Also, there are situations where a number of different people are allowed access to a site and each person has installed his own lock on the site portal. For instance, where a chain is strung across a road to prevent access, the chain may be secured to a post by a padlock. That padlock may belong to a local power company. A second padlock, owned by a regional water management company for instance, may be linked between the first padlock and the chain or post. A third padlock, in this case owned by a first rancher granted access to the site, may be linked between the second padlock and the chain or post. The result is a “chain of padlocks,” one padlock locked to a second padlock, the second padlock locked to a third padlock, etc, and growing into a significantly long chain of locks. This number of different padlocks, each owned or controlled by a separate entity, can grow such that a number of different locks, each with an individual key or combination, are linked together thus giving access to the site to numerous people, companies or organizations each with their own key or combination. In some cases as many as fifteen or more padlocks are linked together, one padlock to the next, resulting in a two to three foot long collection of locks. Some of these locks are high quality locks and some may be inexpensive and easily breached padlocks. The adage that “a chain is only as strong as its weakest link” applies here. The cheap locks negate the security effectiveness of all the high quality locks. To breach the dose a perpetrator need only compromise one of the cheap locks. It would be beneficial if this plurality of locks could be replaced with a single lock mechanism easily accessible by any authorized user. Using one form of the invention described herein, the multiplicity of locks in such a “chain of locks” would be replaced by a single electronic wireless locking system thus ameliorating the need for multiple locks and the use of locks of disparate quality. Another problem associated with multiple locks connected together to form a chain situation is that if a company or person removes its lock from the chain, the chain is now broken as one link is removed and the custodian of an adjacent lock may not be available to hook his lock to the remain locks in the chain.

Another situation where conventional locks, such as padlocks and door locks are troublesome, is where the locks need to be changed periodically for security reasons. In such situations it is possible for a worker, inspector, or authorized user to travel to a remote site and find that the lock has been changed and he has the wrong key or he forgot to bring the right key.

Keys are also problematic in situations where access to a site is needed by a group of people where access is infrequent or revolving. For instance, in a military environment where access to a site is restricted to a class or group of soldiers, it is inefficient to give a key to each soldier. Access controlled by a remote computer will prove to be efficient in such a situation.

It is also known to have access to secured areas controlled by keypad entry devices proximate a locked portal. For instance, a door lock is controlled by the entrant entering a code in the key pad. The keypad is hardwired to a computer, which may be integral with the keypad, and if the code “keyed-in” to the pad is an authorized code, the lock will open. The computer associated with such keypad entries may also be programmed to record the date, time, access code and other information for real time observation or later data reporting. A weakness of this system is that the access code has to be taught to the potential entrant, remembered by the entrant, and not shared with others. Also, keypad entry strokes can be observed, or recorded by unauthorized parties for eventual compromise of the secured portal.

It is also known to use a special wrench having a unique socket that will mate with a complimentary lug to secure a lug on a threaded post. This type of security device is used to secure wheels on cars, certain bicycle U-bolt locks, coin operated dispensing machines. It is also used on a manhole cover security device that will be discussed further on.

Actuation devices are also known that allow access to the holder of a control module that is capable of delivering an infrared, microwave or radio signal to a receiver. Garage door openers are an example. Range on these devices is generally limited, however they do have the programmed capability of changing the access code after each activation. Of course, there is no operator identification normally programmed in these devices. The system can't discriminate one user from another. The match between the signal sending unit and the signal receiving unit is the only control over indiscriminate access to the secured area.

The invention presented here is based on obtaining permission and subsequent access authorization to a remote site by wireless communication from the remote site to a central processor, computer, control center or the like a distance away from the remote site.

### SUMMARY OF THE INVENTION

The invention disclosed herein includes use of a locking module, also referred to herein as “lock module,” controlled in most instances through the use of cellular telephone transmission links. Included is a method of accessing, applying, controlling and using the locking module. The locking module can either be a lock that locks a lock, a primary line of defense that has to be opened before a second conventional lock can be opened; or the locking module can be the primary lock itself.

One embodiment of the locking module comprises a sealed water-tight enclosure having a spring-loaded lid closable to seal a low profile access module. The locking module also comprises a hand cranked generator carried in the lock module. A speaker and a microphone reside in the access module and are protected from exterior elements by the surrounding enclosure, such as, but not limited to a thin film plastic membrane, a water-proof barrier, or by a water-tight lid of the access module. Electronic and visual communication elements are housed in the access module. These elements allow communication through a standard telephone link between a cellular telephone and a remote signal processing computer as will be described below. A retractable locking bolt is slidably carried in the lock module. The locking bolt is movable to a position to lock a device and moveable to a position that will allow opening or access to a secured site or locked device.

One basic form of the invention, in summary, uses a cell phone to make a connection between a base station and a remote lock module. The lock module is powered by a hand cranked generator, and thus the lock module can be used in locations where there is no power; or where it would be too inconvenient, impractical, too costly, or a temporary situation, or where a battery source is subject to maintenance issues alleviated by use of the hand cranked generator. It is expected that there is a need for a local, on-board energy storage device, such as, but not limited to, a battery, a capacitor, a controlled rate of discharge device, to extend the length of time that the energy created by activation of the hand cranked generator is dissipated. In addition to direct storage of electrical energy a mechanical device, such as a spring and escapement system or a flywheel system that is “charged” by the hand cranked generator quickly for slow dissipation by the mechanical device of the generated and stored energy. A specific embodiment is set forth below. Numerous other practical applications are contemplated by the inventor.

One advantage of the invention is that, since communications are directed through a regular cellular telephone, there is no need to supply workers with special equipment, special phones, or other expensive gadgetry. Also, with cellular telephones and the cellular telephone links, there are no governmental regulatory requirements, permissions or licenses believed to be required since those are already inherent in the use of a cell phone.

An advantage to the disclosed system is that it accommodates the needs of company personnel and employees of allied companies who require immediate access to an enclosed, secure area secured with locking barriers, doors, gates, or the like. As this system is an automated system, largely controlled through a central computer system in a base station, the costs to manage the automated system will be insignificant as there are no routine service requirements. Components of the remote systems may be damaged from use or from malicious vandalism, but the inventor contemplates that the mechanical components of the system will be comparable in toughness to security padlock systems.

Another feature and advantage of this invention is that the base station, which needs to be accessed each time a lock module is cycled, is configured to maintain records of barrier and lock module activity. Thus the base station software will have records of barrier and lock module activity, including at least, who, what, when, why, and where each time a lock module or barrier is accessed. Interpretation of the records would aid management and subscribers in knowing the status of a particular secure location, that is, warnings or reminders to supervisors or security and liability managers, that some barriers are still open and have not yet been re-secured. In this scenario the safety of the worker can be considered; i.e., has too much time passed since the worker entered the secured area (indicating a problem), has the worker not exited the site at a proper time, has a gate, door, or other portal cover been left open because the worker is incapacitated in a health risk area, is the worker injured at the site, has the worker gotten lost, has the worker lost his ability to communicate by cell phone, etc. Also if an authorized entrant leaves a secured area without re-securing the barrier or lock related to a particular locking module, the entrant, or his company could be charged a fee to have an attendant re-secure the barrier. These records could be one method of doing business wherein a subscription fee would be charged for lock module customers or users, that is, a fee could be charged for keeping the records, reporting the data, and interpreting the data to assist customers in auditing access to a particular locked secure location. The records could be used for billing purposes as well. For instance, a fee could be charged based on usage of the lock module, however that is primarily an option where there is high volume usage by various individuals, such as real estate agents, accessing keys through a lock box. Another instance is the use of determining work time on the job, that is, the “on-the-dock” time a worker spends on a particular job. This could be the basis for billing for performing a particular job. One more instance of a record keeping function is the reporting of when a worker was at a particular location, similar to a security officer using a location specific key to trigger a record on the recording device he carries from location to location.

Another advantage of this invention is that workers will not be allowed to open a locked module, or a secured barrier, on their own, without first getting authorization from the base station.

This invention requires few service personnel to run effectively. Few, if any, special tools are needed. In most cases, workers already carry the tools they need to operate the lock module, such tools as a cell phone or a satellite phone and, where fold-out drive handles or locally stored handles are not provided, standard hand wrenches, a socket set for instance, are all that is needed.

Another advantage of the invention is that the locking module is a simply constructed device with few moving parts, no batteries to run low, no need for an external source of power which is a consideration where wiring and the possibility of short circuits presents an explosion or shock hazard.

The above summary does not include an exhaustive list of all aspects of the present invention. The inventor contemplates that his invention includes all systems and methods that can be practiced from all suitable combinations of the various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

Various embodiments of the present invention are described below with reference to the drawings, wherein like designations denote like elements.

FIG. 1 is a side elevation view of one embodiment of the invention shown in cross-section with some parts broken away to reveal the operating mechanism of the invention.

FIG. 2 is a top view of the invention shown in FIG. 1 with a portion of the device broken away to reveal the operating mechanism of one embodiment.

FIG. 3 is a portion of the side elevation view of FIG. 1 showing a displayed position of one of the elements of the invention.

FIG. 4 is a top view of a portion of the invention.

FIG. 5 is a top view of an alternative embodiment of the invention.

FIG. 6 is a side elevation view, having some parts broken away to reveal operating mechanism of one aspect of the invention.

FIG. 7 is a front elevation view an embodiment of the invention showing a bar lock.

FIG. 8 is a front elevation of a U-bolt lock embodiment.

FIG. 9 is a front elevation view of a container lock embodiment.

FIG. 10 is the side elevation of FIG. 9 container lock embodiment.

FIG. 11 is a flow chart showing worker activity in handling an access to a lock module.

FIG. 12 is a flow chart showing a flow of activity in processing an access event.

### DESCRIPTION OF PREFERRED EXEMPLARY EMBODIMENTS

The invention is capable of numerous iterations and applications. One embodiment of the invention will be focused on to make the reader aware of the general principles of the invention. A perusal of the drawing figures while carefully reading this specification will provide the reader with an appreciation of the embodiments described, as well as embodiments that are logical extensions of those set forth herein.

The preferred embodiments of the invention presented here are described below in the drawing figures and Detailed Description of the Drawings. Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning.

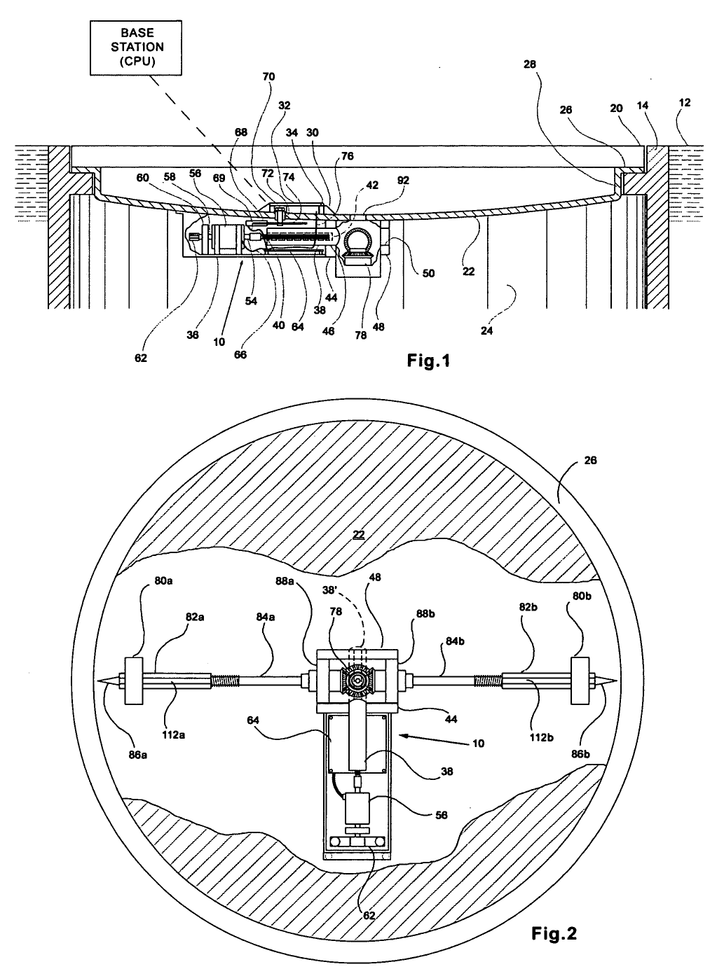

Beginning with FIG. 1, an overview of one embodiment of the invention can be clearly discerned. This embodiment is used to secure a barrier in a man-access-portal that is normally covered with a manhole cover. The lock module is an integral part of the apparatus used to secure the barrier, but it is to be understood that the lock module presented herein can also be used in numerous other situations. For instance, the lock module could be used to control locks associated with access to doors, portals, gates, rooms, buildings, lock boxes, aircraft, boats, cars and anyplace where a lock is used to control access or secure a space. The type of lock that can be controlled by this invention is not limited to those described in detail in the specification. For instance, the inventor contemplates that the type of lock could be a U-lock, a hasp lock, a pad lock, or the like as well as other types of known locks not recited here.

One embodiment of this invention, but by no means the only embodiment of the invention, can be, for example, applied to a manhole cover security device. Such a security device is designed to prevent unauthorized access to manhole covers. One such device is shown in U.S. Pat. No. 6,550,294 of Garguilo, incorporated herein by reference. This device uses a pair of opposed locking members, positionable by a gear set, to provide interference points between the barrier and the host manhole tube. A T-wrench is used to move the gears of the gear set and thus move the locking members. Each T-wrench and gear set are keyed to allow only compatible components to work together and allow releasing or securing of the barrier by means of the locking members. The disadvantages of the need for a T-handle is that they are cumbersome, expensive, and each T-handle has a unique socket limiting its flexibility. However, this known device, the manhole security device of the '294 patent, can be significantly improved by incorporating the instant invention in its operation. One such improvement is the abrogation of the need for unique sockets on the T-handles since, with this invention, the security function of the special keyed lugs and sockets is totally replaced by the electronic wireless locking system. These unique keyed sockets on the T-handles could be removed and replaced with standard socket fittings, such as SAE or metric size sockets, thus making the T-handles somewhat useful and not totally obsolete and extraneous, as now they would have standard SAE or metric size sockets in place of the special keyed sockets, especially where an expensive T-handle is needed to generate a significant torque to turn a valve, open a gate, or drive a gear set.

Returning to FIG. 1, the lock module, generally 10, is shown attached to the bottom surface of a barrier support plate 22. The barrier support plate 22 is located on a support lip or flange 16 beneath a manhole cover 20 as shown in this cross-sectional view of one embodiment of the invention. A recess 14 above the flange 16 allows clearance for the barrier support plate 22 and the manhole cover 20. Pavement 12 surrounds the manhole access passage 24 as is shown in FIG. 1.

The barrier plate 22, generally a circular disc having a concave upper surface, includes a barrier support plate flange 26 extending laterally from a vertical wall 28 of the barrier support plate which extends upwardly from the upper surface of the barrier support plate 22.

An access module 30 is affixed to the upper surface of the barrier plate as shown in the drawing figures. The access module 30 is provided with a lid or cover 32 that is hinged at 34 to the frame of the access module 30. Opening the lid of the access module reveals a cavity containing a charging device input drive shaft and communication apparatus as will be discussed further on.

On the bottom surface of the barrier support plate 22, a lock module housing 36 is fixedly attached. The lock module housing 36 contains several items. A deadbolt 38 is shown in a retracted position in the lock module housing. Although a “deadbolt” is shown in this embodiment a displaceable lock element of any type is contemplated by the inventor.

The deadbolt 38 is movably driven by a screw actuator 40 that is threaded into a threaded or partially threaded bore 42 of the deadbolt 38. The bore of the deadbolt need not be threaded for its entire length, for instance, a half inch deep threaded insert, or the like, can be used as long as it allows the threaded rod to move through the bore of the deadbolt.

A motor 56 has an output shaft 54 that is operatively connected, in this example, by a coupling 52 to the screw actuator 40 of the deadbolt, or generically, to the displaceable lock element. As the output shaft 54 turns, the deadbolt; which may be made with a key or a keyway along its length to keep it from rotating; will move inwardly or outwardly through a keyed aperture 46. The keyed aperture is compatible with the key or keyway in the deadbolt. An alternative to the key or keyway structure is to use a non-round, in cross-section, dead bolt, i.e., the dead bolt can be square, or rectangular or other cross-sectional shape and fit into and through a square, or rectangular, or other cross-sectional shape opening. The shape of the deadbolt is a designer's choice, it simply has to resist rotary motion when a threaded drive rod is acting on the deadbolt. The deadbolt moves through an inboard deadbolt support 44, depending on the direction of motor rotation. An outboard deadbolt support 48 is also provided. It has a keyed aperture 50 similar to the keyed aperture 46 in the inboard deadbolt support 44.

Direct drive of the screw actuator by the motor may impose an energy inefficient, high torque load on the motor. Thus it may be advantageous to use a gear reduction drive between the motor and the output shaft to reduce the motor load.

Alternatives of the motor can be, but are not limited to, a solenoid, a pneumatic or hydraulic actuator, each having a pressurized fluid reservoir or pressurization capability, a piston and ram assembly, or the like.

The motor 56 also incorporates an aligned shaft 58 that connects to a ratchet housing 60 and to a ratchet rocking lever arm 62. This assembly of the aligned shaft 58, the ratchet housing 60 and the ratchet rocking lever arm 62 is used to turn the screw actuator 40, and thus position the deadbolt 38, when the motor is inoperative. This backup feature of the invention will be more completely described further on.

Motor control is directed through circuitry on a printed circuit board 64, also referred to as a communication control module, that is connected by motor conduit 66 to the high-torque motor 56. The printed circuit board 64 is also connected to a charging device 68. Electricity to power the motor 54 and to power the communication circuitry on the printed circuit board is provided by the charging device 68. The charging device 68 will be connected to the printed circuit board by a conduit 69 that may, as an alternative, connect to a battery (not shown) which, in turn, is connected to the printed circuit board. Circuitry on the printed circuit board is designed for at least two operations. One operation is to control the motor 54, directing it to rotate its output shaft in a first direction to urge the deadbolt 38 into a locked position or in a second direction to urge the deadbolt 38 to an unlocked position in the lock module housing 36. Another operation of the circuitry on the printed circuit board is to interpret and act on communications being sent to the lock module by and through the cellular telephone, to which the printed circuit board is operatively connected through an audio link or a hardwire link. The cellular telephone, or other portable communication device, such as, but not limited to a satellite phone, a personal digital assistant, a palmtop or laptop computer, or dedicated wireless device, is used as the communications link between the lock module 10 and a base station 114 (shown as a generic box in FIGS. 1, 4, and 5).

As will be apparent from further reading of this specification, the base station 114, which comprises a communications link and a computer for generating a control signal, is accessible by radio-frequency transmission, infrared transmission, hard line transmission, or the like, through the use of a cellular phone, or its equivalent, dialing into the base station computer and communication systems. The printed circuit board 64 is not limited to the two functions mentioned above and indeed will have many normal and necessary circuits, such as voltage control, an A/D converter circuit, input terminals for various sensors, and the like. For instance, the printed circuit board may process other input signals such as air quality monitoring probes, temperature sensors, and a microphone and speaker other than the microphone and speaker used for communication between the cellular telephone and the base station. If these special sensors or apparatus are provided, the locking module can also be programmed to immediately warn a worker about to open the barrier of a dangerous gas, or high level of fluid, of fire behind the barrier, or other dangerous elements, possibly humans waiting in ambush to consider an extreme example, or conditions behind the barrier before the unlocking activity takes place. Signals from the sensors would, in one embodiment, be sent directly to the base station using the worker's cell phone link and the base station will then quickly send an appropriate audio or electronic warning back to the worker. Alternatively, the warning could be immediately communicated to the worker without a transmission to and from the base station with the warning and the sensor signals simultaneously sent to the base station.

Furthermore, the inventor contemplates that the printed circuit board can be equipped with circuits related to light level detectors, vibration detectors, as well as other functions, such as a timing circuit for timing activities, that would enhance the operation of the lock module. The timing operations could include, but are not limited to, time of day information, time the lock was unlocked or locked, a limit or window in which the lock will operate, i.e., access denied except during the hours between 9:00 am and 5:00 pm, or other time related data and activities. Another sensor system that may be used is a system of strain gages fastened to the locking rods of the barrier securing system. The strain gage inputs would show if the probe tips of the locking device were in good, solid contact with the walls of the manhole. Also, a simple position sensor could be wired to the printed circuit board to communicate to the base station that the barrier is flat and properly disposed on the barrier support plate flange 26. As alluded to above, the printed circuit board could house a battery or be connected to a battery, however, in this preferred embodiment a battery is not necessary.

In one preferred form, the printed circuit board would be a secure “potted” device to enhance its resistance to an adverse environment and make it tamper resistant.

A charging device 68, as one alternative source of power, is integral with the lock module in this preferred embodiment. The charging device will either produce sufficient energy to power the motor 56 in its task of moving the deadbolt or will be used to charge a battery, a capacitor, or fill an energy reservoir, that will store energy and allow energy use over the time period needed to operate the locking module, the latter being the preferred embodiment. The charging system, and the storage system in systems where one is provided, will also provide power needed to run any other functions on the printed circuit board or associated with the lock module. Operation of the charging device is known, as this type of crank generator is generally available. The charging device 68 will have an input drive shaft 70, journalled in a bushing 72, connected to a disc 74 designed with a surface having conductive sections spaced apart from non-conducting sections. The input drive shaft 70 is rotated, by a lever such as a standard 7/16 inch socket compatible with the head of the input drive shaft; or a wrench handle; a dedicated handle; or by a “flip-out-to-operate” drive handle; an electrically driven handle, battery or line powered; or the like; to rotate the disc 74, to generate electricity.

In addition to the hand cranked generator as a source of power, other power sources are contemplated such as, but not limited to, battery power, solar power, hardwired electrical sources, fuel cells, and combinations of these. Also, where a hand cranked generator is used, the inventor contemplates using it to wind a spring or set a flywheel in motion, to provide a mechanical storage of energy that can be released in a metered manner to generate energy to operate the locking module.

FIG. 1 shows a simplified representation of a gear set 78 that is accessible through aperture 92 in the barrier support plate 22. This gear set is more clearly shown in FIG. 2.

FIG. 2 presents a top view of the locking module 10, with parts either removed or partially broken away and left out of the drawing to enhance the clarity of the drawing figure. The gear set 78 is clearly seen in this figure. As shown in the Garguilo U.S. Pat. No. 6,550,294, the gear set is rotatable, using a T-wrench having a keyed socket end compatible with the socket end receiver of the gear set. The T-wrench is inserted through the aperture in the barrier support plate (92 in FIG. 1). In the inventor's embodiment shown in FIGS. 1 and 2, the T-handle and its matching keyed lugs are replaced with standard size conventional sockets and corresponding conventionally sized hex drive.

The barrier support plate 22 is partially broken away in this figure.

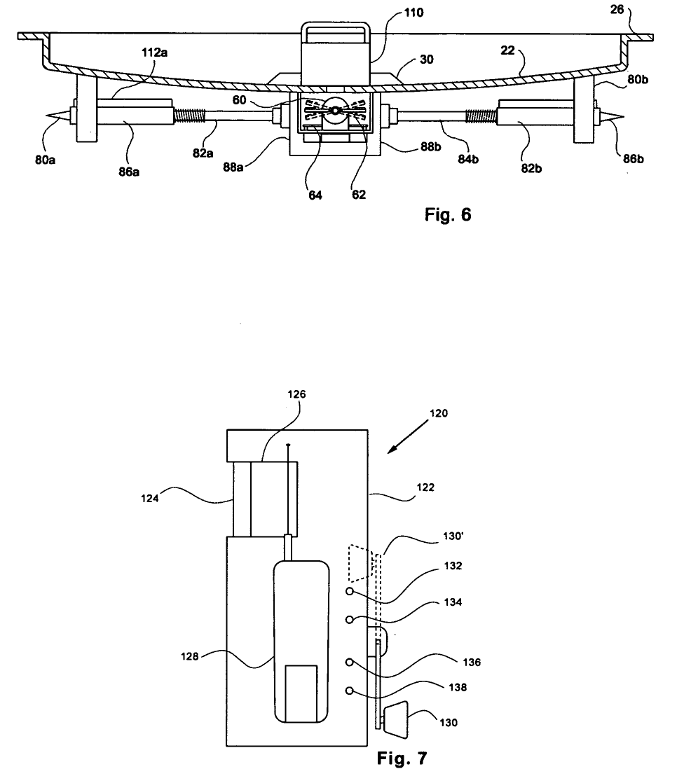

When the gears of the gear set 78 are turned the externally threaded rods 84a and 84b will cause the internally threaded sleeves 82a and 82b (each having keys 112a and 112b that fit into keyways in the brackets 80a and 80b) to move outboard on the threaded rods through the brackets 80a and 80b. Brackets 80a, 80b, and vertical gear set supports 88a and 88b are fixed to the bottom surface of the barrier support plate 22 as best seen in FIG. 6.

Continuing with FIG. 2, the probe tips 86a and 86b are urged into interference contact with the wall of the access passage 24 upon outward displacement of the externally threaded rods and sleeves. To remove the probe tips 86a and 86b from contact with the wall of the access passage the gears of the gear set will be rotated in a second direction. With the probe tips not in contact with the wall the barrier support plate 22 can be lifted out of the access passage.

The locking module 10 shown in FIG. 2 is the enhancement to the barrier known in the art. In this figure the deadbolt 38 of the locking module is depicted in a retracted displacement. This allows access, through the aperture 92 (FIG. 1), to the gear set 78. One element of the gear set that is modified, if desired, when the locking module is positioned on the bottom side of the barrier support plate 22, is that the specially keyed socket end receiver of the prior art gear set can be replaced with a simple 15/16 inch (or other common SAE or metric) hex-head as mentioned above. The use of a conventional hex-head will eliminate the need for a special keyed T-wrench, one of the features of the design shown in U.S. Pat. No. 6,550,294. This keyed T-handle wrench feature of the prior art is not a desirable feature. In the prior art barrier latching system, service personnel servicing the barrier latching system will need access to a keyed T-handle wrench, or at least a keyed socket, compatible with the special socket of the prior art latching system, when the service person needs to lock or unlock the prior art latching system. This is undesirable situation as service personnel will have to make sure they have the expensive, cumbersome and compatibly keyed T-handle wrench with them when they go to the field to open a barrier support plate as taught by the prior art.

In addition to the deadbolt 38, the inboard 44 and outboard 48 deadbolt supports, the motor 56, the circuit board 64, the ratchet housing 60, the ratcheting rocking lever 62, and attendant hardware are shown in FIG. 2. Additionally, a phantom representation of the position 38′ of the deadbolt when it is in an extended displacement is shown. With the deadbolt 38 extended to the phantom position 38′, the aperture 92 (FIG. 1) above the gear set 78 is sufficiently blocked to prevent access to the gear set drive element. This blocking prevents rotation of the gear set and retraction of the probe tips 86a and 86b from interference with the wall of the access passage. Without the deadbolt positioned above the gear set, access to the gear set is open. In the Garguilo device, the U.S. Pat. No. 6,550,294 mentioned above, the gear set is accessible, as there is no deadbolt obstructing access to the gearset.

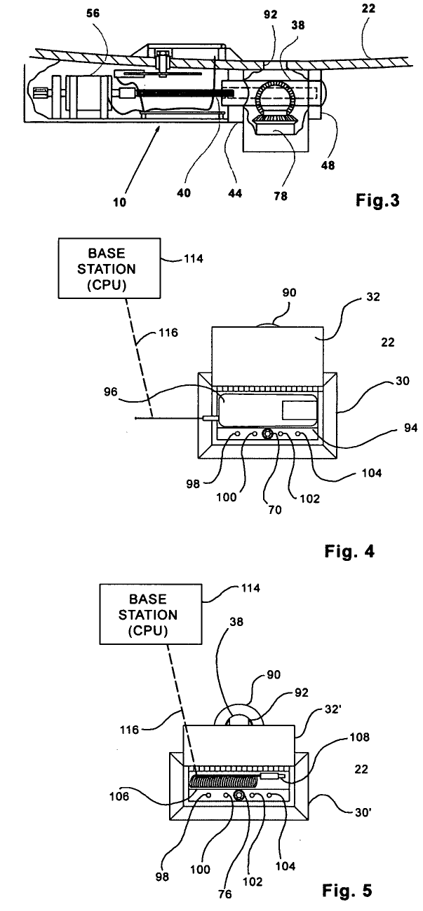

FIG. 3 depicts a portion of FIG. 1, leaving unnecessary detail out of the drawing. FIG. 3 shows the method whereby the deadbolt blocks access to the gear set 78 through the aperture 92 in the barrier support plate 22. Here the motor 56 has been actuated to draw the drive screw 40 out of the deadbolt 38 causing the deadbolt to pass through the inboard 44 and outboard 48 deadbolt supports. The deadbolt, in this deployment, is secure in the apertures of the deadbolt supports and is not easily displaced. Furthermore, the deadbolt 38 is in close proximity to the lower surface of the barrier support plate. In a production design it can be even closer than shown in the drawing figures. By being close to the bottom of the barrier support plate 22, and under the aperture 92 in the support plate, it will partially block the aperture 92. This is an advantage that overcomes one of the deficiencies of the art. That deficiency is that the barrier plate could be pulled out of its secured position by inserting a hook through the aperture 92, attaching the hook to the bumper of a vehicle, and dragging the barrier plate out of the manhole. In this form of the invention the deadbolt is located so that it would be difficult to insert a large hook through the aperture 92. If a big enough hook can't be easily hooked to the barrier through the aperture, this method of forced removal of the barrier is eliminated from a perpetrator's arsenal.

FIG. 4 shows a top view of a portion of the lock module, barrier support plate, and base station as detailed in FIG. 1. In this figure the upper surface of the barrier support plate 22 supports the access module 30. The access module lid or cover 32 is flipped open partially covering a structural ring 90 that surrounds the aperture 92 (not visible). An interior compartment 94 is sized to generally accept a cellular phone 96. In a preferred embodiment the cell phone 96 does not need to be placed into the interior compartment 94 but is held one inch or so above the floor of the compartment whereby the speaker and the microphone can be picked up by complimentary speaker and microphone elements in the interior compartment.

With the lid 32 open, the charging device input drive shaft 70 is visible. Adjacent the drive shaft are a set of lights used to convey information to service personnel accessing the locking module. These lights are: a “power” light 98, which, when flashing will indicate that there is enough power to operate the system; a “communications” light 100, which when flashing, will indicate that there is ongoing data transmissions in process between the cell phone, the base station and the lock module; a “message” light 102, indicating, when flashing, that the service personnel should pick up the cell phone and talk directly with the base station 114; and an “all done” light, which when lit indicates that all communications between the base station and the cell phone and lock module are complete and the service person can remove the cell phone and close the lid 32.

FIG. 5 presents an alternative embodiment to the embodiment shown in FIG. 4. In the FIG. 5 embodiment the cell phone is not held in proximity to the speaker and microphone of the access module 30 for communication. Instead, the FIG. 5 embodiment uses a cell phone jack cable 106 that will plug into a compatible standard 2.5 mm female jack of the cell phone. The male jack 108 will be at the terminal end of the jack cable 106. All the communication features between the cell phone, the locking module and the base station will be through this cable 106 instead of the audio connection set forth in the FIG. 4 embodiment. Functionality is thus the same, although the use of the cell phone jack cable 106 may be preferred where the lock module is in an area where there is noise interference that would jeopardize a dean communication signal between the cell phone with the audio connection and the base station.

FIG. 5 also shows a portion of the deadbolt 38 visible in the aperture 92, as well as the optional structural ring 90. These elements are visible since the access module cover 32′ is smaller in this embodiment.

The use of a cell phone or satellite phone as the communication link between the lock module and the base station is discussed herein. Cell phones come in a variety of sizes and shapes. The placement of the cell phone one inch away from the speaker and microphone proximate the access module cavity, for the ten seconds that it is expected will be needed for communication between the lock module and the base station, will accommodate many phone sizes and is practical, sanitary and convenient.

As an alternative to the use of a cell phone, a company controlling the lock module could issue a dedicated communication device to its authorized employees, rather then relying on a cell phone for data transmissions. Another embodiment is use of a simple recording device. This is a back up or emergency key option. Before heading out to the secure site, a worker would access the base station and download the coded signals that are needed to open the lock module. The worker then takes the recording to the site and places the player proximate the microphone of the locking module. He plays the recording and the locking module opens. Ideally, the worker would have also recorded the signal to relock the lock module. This is a one time only usage generally intended as an “emergency key.” It is helpful where a cell phone system isn't functional.

There are certain times and locations where cell phone service is not readily available, for instance, in nation border areas cell phone transmissions are jammed. Sometimes cell phone networks are “down” due to malfunctions, overloads, scheduled or required shutdowns, or the like. In those cases the “emergency key” technique set forth above may be helpful to let authorized workers to enter a secure area.

Another alternative to a cell phone is to have a keypad built or carried integrally with the access module. Entry codes could be changed after every transmission or use based on an encrypted handshake algorithm in the base station and the access module.

FIG. 6, depicts another partially broken away side elevation view, and is presented to show a preferred form of a backup actuation system that moves the deadbolt. In this view a ratchet housing 60 is shown including a ratchet mechanism similar to the mechanism found in a ratchet wrench. It can be a ratchet gear wheel with a pawl engagement that allows one way rotation of the ratchet gear which is attached to the aligned shaft 58 and to the screw actuator 40 (both FIG. 1) used to move the deadbolt. As the ratchet is ratcheted the screw actuator 40 will be turned. The ratchet mechanism in the ratchet housing 60 can be reversible by use of an operating magnet for determining direction. A ratcheting rocking lever 62 is used to drive the ratchet mechanism. The lever is a generally horizontal two-eared lever arm as clearly shown in FIG. 6. The lever arm will be of a magnetic material or, as an alternative embodiment, be equipped with magnetic inserts or buttons. The lever arm 62 is fixedly attached to the aligned shaft 58 which is, in turn, attached to the ratchet mechanism. The operating magnet mentioned above is the pulsing electromagnet 110 shown removable positioned on the top of the barrier support plate 22. In operation the pulsing electromagnet 110 will be set on the barrier support plate proximate the ratcheting rocking lever 62. It will be actuated to provide an electromagnetic pulse that will attract one side of the ratcheting rocking lever arm 62 while repelling the other side of the ratcheting rocking lever arm and thus ultimately turn the screw actuator 40. Reversing the pulsing electromagnet will drive the ratcheting rocking lever arm 62 in a second or reverse direction to urge the deadbolt in a second direction.

FIG. 7 shows another embodiment of the invention. In this figure a “bar” lock, generally 120, is shown. The bar lock includes a housing 122 that supports a bar 124 that is moved laterally, generally aligned in the direction of the major axis of the housing, in the housing to provide a locked displacement as shown or an unlocked position where the bar 124 is moved to allow access to the cavity 126. The bar lock of this embodiment contains operating mechanism as disclosed with regard to the barrier lock module generally 10 as shown in FIGS. 1-6. That is to say that the operating mechanism and the operation of the bar lock is similar to the operating mechanism and operation of the lock module discussed above. The difference is the configuration of the mechanical package of the lock module and the resultant portability of this embodiment. In operation, through the translation of the bar 124 from a locked position to an unlocked position and back, this embodiment, to the extent it can be given the package, functions in the familiar way set forth above. This embodiment is for use as a more portable device than the barrier locking device. It can be used for locking a hasp, links of a chain, a tab and receiver configuration and such. The cellular telephone 128 is shown in a position where it would be within an inch of a microphone and speaker integral with, but hidden from view in FIG. 7, the housing 122. The hand crank 130, for cranking the hand cranked generator as described above, is shown in a deployed position 130 with a phantom line position 130′ representing the stowed position of the handle. When the handle isn't needed for cranking the generator it can be stowed as shown in position 130′. The light set as used in the previously described embodiment can also be incorporated in this embodiment. To that end the power light is shown as 132, the communication light 134, the message light 136, and the “all done” light 138.

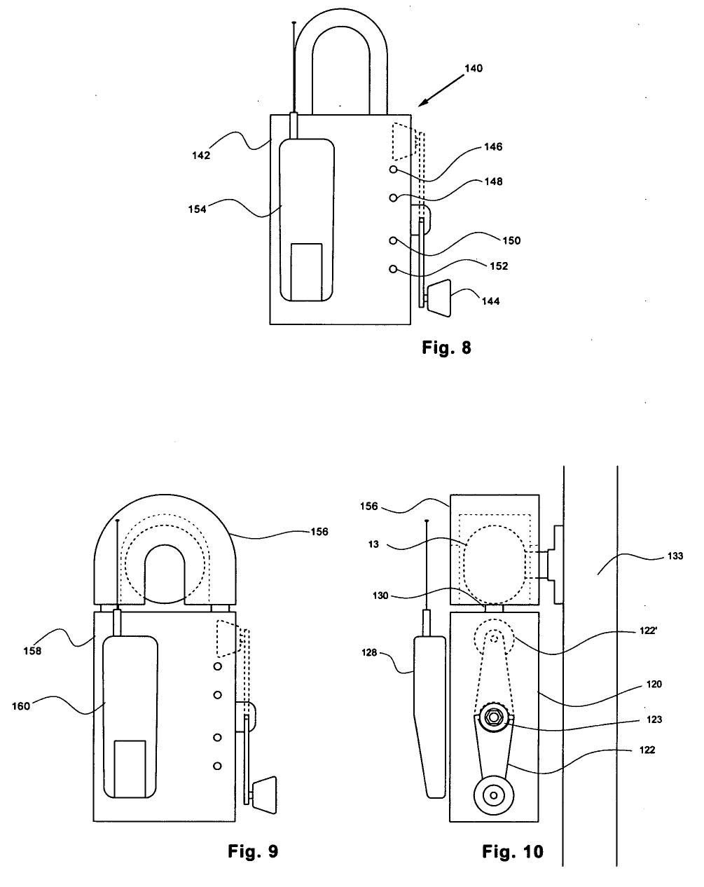

FIG. 8 is similar to FIG. 7 in as much as a portable device is shown. In this embodiment a U-bolt lock mechanism, generally 140 is presented. The housing 142 is provided with the hand crank 144 and the series of lights including the power light 146, the communication light 148, the message light 150, and the “all done” light 152. In the embodiment shown in FIG. 8 the cellular phone 154 is positioned left of center. In this embodiment the phone position is offset left to leave a large opening inside the “U” portion of the lock. The position of the cellular phone and the position of the speaker and microphone, both hidden under the phone in FIG. 8, is determined by designer's choice and the packaging of the componentry inside the housing 142. The U-bolt locking module shown in this figure will operate on the principles set forth above and simply is illustrative of the scope of locking devices that can incorporate the locking module taught by this disclosure.

Another embodiment is shown in FIGS. 9 and 10. This embodiment is similar to the U-bolt configuration of FIG. 8 with the addition of a container 156 whick may be integral with the “U” of the U-bolt lock shown in FIG. 8. The container lock, generally 158, has a container 156 that can fit over, as an example, a door knob. This will find utility as a lock box on homes that are being sold. Instead of a “lock box” hung on the door knob of the house on sale, the container locking module would be used. One advantage is that keys in the prior art lock box tend to disappear. The other advantages of the invention, such as the record keeping aspect, apply very well to the container locking module shown in FIGS. 9 and 10. It is clear why, in FIGS. 8-10, the cellular phone is setup to communicate from the left of center, that is the antenna of the cellular phone can clear the opening for the shaft of the door know if the cellular phone is offset.

Several forms of the inventive apparatus are set forth above. However, the nuances of the structure will be further understood in reference to the description of its method of use and operation, below.

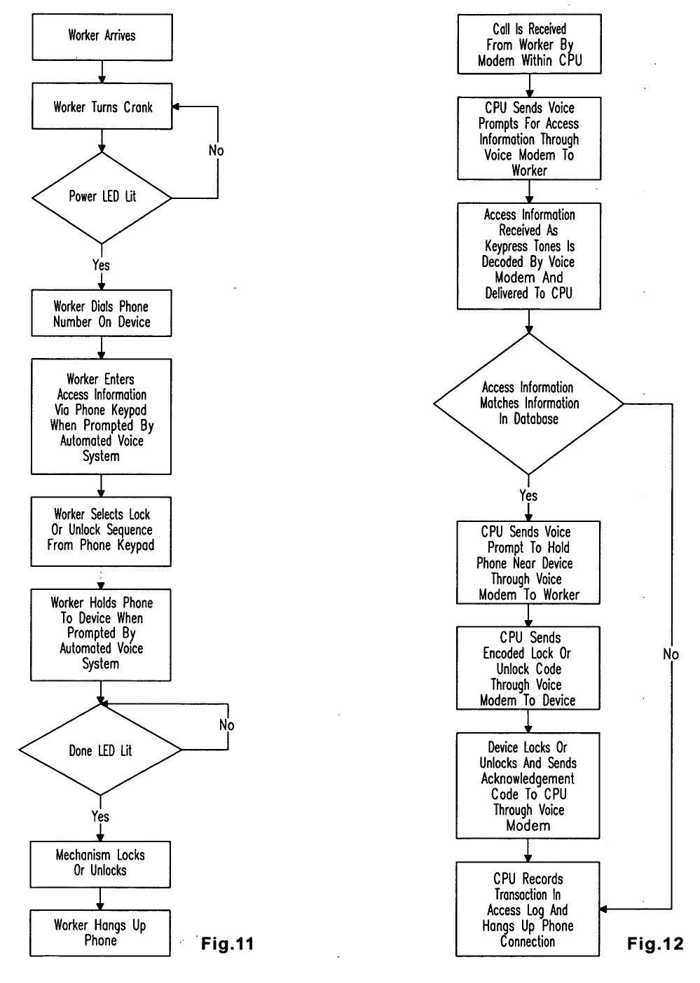

FIGS. 11 and 12 a flow charts that depict one embodiment of the operation of the invention. In FIG. 11 the worker interface with the locking module is described in a general form. The flow chart is largely self-explanatory. The worker arrives and cranks the hand crank generator until there is power needed to power up the lock module. Once there is power the worker will dial a phone number on his or her cell phone, in one embodiment the number will be a toll free number, and, once the phone has been answered, the worker will enter access information as requested. The worker may need to select whether he wants to lock or unlock the lock module although in one embodiment the base station will know whether the module is locked or is unlocked. The worker will position his or her cell phone proximate the lock module so that the microphone and speaker of the cell phone and of the locking module are within range of each other. The base station will communicate with the locking module and when its communication is complete the “all done” light emitting diode will be turned on, the lock module will be locked or unlocked as appropriate and the worker can hang up on the call. The flow chart is somewhat simplified and more description of the operation follows after the brief discussion of FIG. 12.

In FIG. 12 a basic flow chart of the communications scheme is presented. Deviations are expected from this basic flow chart however it is being provided to help explain the invention herein. The operation starts when a call is received from a worker in the field that needs access to a secure location (or is locking a location). The base station, with the computer controlled operations, will respond to the call and exchange access information between the worker and the base station. If the access information provided by the worker doesn't match the information needed by the base station CPU, a record will be made and the base station will hang up on the worker. If the access information matches the base stations data base information the base station authorizes access. The base station tells the worker to set his cell phone in a communication window proximate the lock module. The base station or CPU will communicate unlock or lock codes to the lock module and the lock module will respond by locking or unlocking as directed by the base station CPU. Upon completion of the transaction/communication, the base station CPU will record a transaction record in an access log and terminate the call. The worker will then proceed to remove the lock and enter the secure area. If the worker is departing the secure area or locking an object the locking operation is complete after the base station tells the lock module to relock the lock.

The following description is specific to the manhole cover barrier while the above general procedure, as illustrated by flow charts FIGS. 11 and 12, is helpful in understanding the general operation as well as the manhole cover barrier operation.

The operation of the locking module is described in the context of the manhole barrier cover, which is only one of many embodiments contemplated by the inventor where the locking module can be used, is to provide a lock module at a remote job site, for instance, a manhole of a city street.

The lock module, generally 10, is given lock and unlock commands from a base station 114. The base station 114 is essentially a computer with dedicated software. The base station can be totally automated and serve a limited area, one community for instance, or it could serve a larger nation-wide area. One base station could be set up to manage all electronic barrier locks from the one location. Sufficient backup locations are also contemplated such that no interruption in lock module management service would occur if the primary base station became inoperative. A base station includes a computer processing unit (“CPU” in FIGS. 1, 4, and 5). The base station is located in an office facility generally remote from the lock module. The base station 114 communicates over a standard telephone link, represented by path 116 in FIGS. 1, 4 and 5, with the lock module 10 using a cell phone 96 routinely carried by technicians working “in the field.”

The base station will house standard communications hardware and software. There will be a receiver for receiving incoming calls, communication capability between the receiver and a central processing unit, incoming call answering software as is conventionally known in automated telephone answering equipment and message sending software that will send and receive encrypted and/or unencrypted data to the cell phone at the remote location of the lock module. The CPU will be programmed to allow access to authorized incoming calls. It will provide outbound data for use in operating the lock module and will also monitor and take action based on data received through the communication link. The CPU will also be provided with record keeping software that will store, analyze, process, and output data useful in the control and record keeping function helpful in administering a security related business.

To access a manhole at a remote job site, the field worker will remove the street-level outer cover or manhole cover 20 to access the access module 30. Instructions for taking steps to unlock and lock the lock module will be printed on the access module. The worker will flip open the lid 32 of the module 30 and crank the generator for a short period of time, on the order of ten seconds; using a wrench, speed-handle, or the like to provide enough power to operate the lock module for the next five minutes. The “power” light 98 will come on indicating that the worker has cranked the hand cranked generator enough to perform the unlocking operation. Once power is supplied to the lock module the worker, who is proximate the locking module, will dial the number of the base station on her cell phone. The base station is accessed, in one embodiment through an automated toll free number.

Upon establishing a connection, the base station, using a human voice interface, will instruct the worker to enter her personal or company identification number, other identification and cross-checking information, and the serial number of the barrier that she wants to unlock or lock using the touch tone keys on her cell phone or by speaking words recognizable by a voice recognition system at the base station. After the base station identifies the worker and authorizes access, the worker is instructed to place her cell phone, usually with the keyboard facing the access module, proximate the microphone and speaker in the cavity or interior compartment 94 of the access module. A picture of a cell phone in proper position above the cavity of the access module may be provided to clue the worker as to the proper location and position for cell phone placement. The cell phone need only be held within an inch or so of the microphone and speaker in the access module, a distance normally used when speaking into a cell phone, for the cell phone to receive instructions to lock or unlock the lock module, in this embodiment, to move the deadbolt 38. The worker will also be told to retrieve her cell phone when the “all done” light 104 comes on indicating that the call is finished. After receiving the “all done” blinking light, the worker will remove the cell phone, end the call, and then close the access cover 32 of the access module.

In the event that the “message” light is blinking when the lock module is in the process of communicating with the base station, the instructions will inform the worker to pickup the phone and listen to instructions from the base station. The “message” light is an indication that there is a message that the base station wants to communicate to the worker.

The base station 114 is now in communication with the lock module 10 and will turn off the “power” light and turn on the “communicating” light 100. The cell phone is the vehicle or means by which secure encrypted data and commands are actively transferred back and forth between the lock module and the base station. During the communication time, the “communicating” light will be flashing, encrypted information is exchanged by the base station 114 with the lock module via the cell phone 96. The information may include confirmation of the serial number of the barrier, the serial number of the lock module, a history of who is at the barrier now and who has been there in the past, and the command or authorization for the lock module to retract the deadbolt 38 allowing access to the gear set 78.

When the base station 114 is finished communicating with the lock module, it will end the call, turn off the “communicating” light 100 and turn on the “all done” light 104. The total time from when the toll free call is made from the worker's cell phone to when the phone is removed, will only take about a minute.

With the deadbolt 38 retracted, the worker can use a standard socket and ratchet, such as a 15/16 inch socket and drive handle, to engage the hex-head drive shaft and open the barrier so it can be removed.

To lock the locking module and reinstall the barrier, the worker will first put the barrier support plate 22 into the access passage on the barrier support lip 16 and use the standard socket and drive to turn the gear set to extend the lock rods. With the barrier plate in position and the probe tips 86 of the lock rods in contact with the walls of the access passage, the same phone procedure is used to re-engage the electronic lock module. The worker will wind the hand generator charging shaft about ten turns and watch for the “power” cue light 98 to come on. He or she will then use a cell phone to call the toll free number to reach the base station. The base station will ask the worker to enter his or her identification number and the serial number of the barrier or lock module using the touch tone keys on the cell phone or by speaking the information into the cell phone. After the identification information is entered the base station 114 will tell the worker, who will be proximate the locking module, to place the phone near the speaker and mike of the access module. The base station will also remind the worker to retrieve her cell phone when the “all done” cue light 104 comes on.

The base station will communicate with the lock module and the worker will know that communication was established as the “power” cue light went off and the “communicating” light 100 went on. Encrypted information will be exchanged between the base station 114 and the locking module 10 and the base station will authorize and command the locking module to relock the barrier by having the motor 56 drive the screw actuator 40 to urge the deadbolt 38 into position blocking the access hole 92 in the barrier support plate 22. When the base station is finished communicating with the lock module, and the dead bolt is in the locked position, the base station will end the call, turn the communicating light off, and turn on the “all-done” light. With the barrier support plate now secure the worker can replace the street-level outer cover 20.

In one form of the invention, it is contemplated that separate cell phone calls are required to unlock and relock the locking module.

Another embodiment includes the use of cell phones and related technology that have visual and text collection and transmission capability. In the case of cell phones, many are now equipped with camera and image processing capability. This gives the user the ability to, for instance, “read” and record a data image, such as a bar code or code containing graphic. That image can be sent through the cell phone communication link to the base station. The information in the data image may include the serial number of the lock module as well as other information pertaining to the lock module or the lock module type, location, history and etc. In addition, the cell phone could be used to take a picture of the cell phone operator, perhaps in the environment where the lock module is located, and send that picture back to the base station for verification of identification of the worker that is about to open or close a secured element controlled by the locking module. The image of the worker, of his/her identification card, or of an image, either text or graphic, on a work order, could be evaluated by an attendant at the base station or could be automatically evaluated by “signature” recognition software, anthropomorphic, or facial character recognition software, or the like, installed on the base station computers. Once authorization is given the opening and closing of the locking module would proceed as set out above.

Various features, sub-combinations and combinations of this invention can be practiced with or without reference to other features, sub-combinations and combinations of the invention, and numerous adaptations and modifications can be effected within the spirit of the invention. While particular embodiments of the invention have been shown and described, it will be obvious to those skilled in the art that changes and modifications may be made without departing from the invention in its broader aspects, and, therefore, the aim in the appended claims is to cover all such changes and modifications as fall within the spirit and scope of the invention and the following claims. For instance, the cavity in the access module is not a requirement for every embodiment as the cell phone need only be placed within an inch of a microphone and a speaker associated with the lock module. The access module itself is only one embodiment and the inventor contemplates that the speaker, mike, cue lights and generator can be built integral with, and flush with, the surface of the barrier.

Another example of an alternative embodiment is the use of a cell phone and the base station methodology for use with pad locks and hasp locks, in addition to the deadbolt and U-bolt iterations discussed above. Also, although the use of the lock module was described in the environment of a manhole cover the inventor believes there are strong application possibilities in protecting a list of places and equipment. For instance, but not to be limited to, the lock module is useful in numerous environments, such as: remote sheds or storage areas, outside or in larger structures such as warehouses or apartment buildings; securing heavy equipment; securing automatic teller machines; bicycles or bicycle racks at schools; security carts or vehicles at malls, stadiums, restaurants, and in parking lots; security and access to homes of elderly or house-bound persons; security of, and access to, hatches on boats and trains or in aircraft; and security or museums, and the like. Such design and application nuances are contemplated as being within the scope of the invention and intend to be covered by these claims. Accordingly, neither the above description of preferred exemplary embodiments, nor the abstract defines or constrains the invention. Rather, the issued claims variously define the invention.

Each variation of the invention is limited only by the recited limitations of its respective claim, and equivalents thereof, without limitation by other terms not present in the claim. Likewise, the use of the words “function” or “means” in the Detailed Description of the Drawings is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically state the phrases “means for” or “step for” and a function, without also reciting in such phrases any structure, material or act in support of the function. Even when the claims recite a “means for” or “step for” performing a function, if they also recite any structure, material or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

1. A lock actuation apparatus, comprising:
a base station including;
a communications link, and
a computer that generates a lock control signal transmitted through the communications link;
a portable communication device operatively coupled to the base station;
a lock module including;
a displaceable lock element,
a motor operatively coupled to the displaceable lock element,
a source of power coupled to motor, and
a communication control module operatively coupled to the motor and to the portable communication device, and configured to (i) receive the lock control signal communicated from the base station through the portable communication device and (ii) directing activity at the lock module.

2. The invention in accordance with claim 1 wherein the portable communications device comprises a cellular telephone.

3. The invention in accordance with claim 1 further comprising a source of power coupled to the motor wherein the source of power comprises a hand-cranked generator.

4. The invention in accordance with claim 2 wherein the motor comprises an electric motor having an output shaft operatively connected to the displaceable lock element.

5. The invention in accordance with claim 2 wherein the displaceable lock element is displaceable from a first position, whereby a lock will be locked, to a second position whereby the lock will be unlocked.

6. The invention in accordance with claim 5 wherein the lock element comprises a deadbolt.

7. The invention in accordance with claim 5 wherein the lock element comprises a U-bolt.

8. The invention in accordance with claim 2 wherein the motor comprises a solenoid.

9. The invention in accordance with claim 1 wherein the communication control module comprises signal-processing circuitry configured to process signals from the base station transmitted through the communications device and an output circuit generating a signal to operate the motor.

10. Lock module apparatus, comprising:
a displaceable lock element;
a motor operatively coupled to the displaceable lock element;
a communication control module operatively coupled to the motor.

11. The invention in accordance with claim 10 wherein the motor comprises a pneumatic cylinder and piston assembly having a source of pressurized air, the assembly configured to move the displaceable lock element from a first position to a second position.

12. The invention in accordance with claim 10 wherein the communication control module comprises signal-processing circuitry that processes digital information and outputs a signal to operate the motor.

13. The invention in accordance with claim 12 wherein the communication control module comprises circuitry that communicates with a cellular telephone.

14. The invention in accordance with claim 12 wherein the signal processing circuitry includes an audio transceiver.

15. The invention in accordance with claim 14 wherein the control module processes the audio signals and outputs a lock control signal to the motor to initiate displacement of the displaceable lock element.

16. A barrier including a barrier support plate that controls access to a walled passageway and supporting a locking system, the locking mechanism having a gear set, extendable rods positionable by actuation of the gear set, and probe tips carried at the end of the rods engageable with the walled passageway, wherein the improvement comprises:
a support mounted to the barrier support plate;
a displaceable lock element supported by the support;
a motor operatively connected to the displaceable lock element;
a communication control module operatively connected to the motor.

17. The invention in accordance with claim 16 wherein the displaceable lock element comprises a deadbolt having a threaded bore.

18. The invention in accordance with claim 17 wherein the motor comprises an electric motor having a threaded output shaft threaded into the threaded bore of the deadbolt configured so that the deadbolt may be laterally displaced by actuation of the motor.

19. The invention in accordance with claim 18 wherein the communication control module includes circuitry configured to communicate with a cellular telephone.

20. A method of operating a lock module, comprising the acts of;
providing a base station having a central processing unit and configured for wireless communication;
locating a lock module at a secured location and configuring the lock module for wireless communication;
communicating to the base station with a cellular telephone;
transmitting lock control data from the base station to the lock module through the cellular telephone.

21. The method of claim 20 further comprising the act of using the cellular telephone to communicate between the base station and the lock module.

22. The method of claim 20 further comprising the act of using the cellular telephone to communicate with a person proximate to the lock module.

23. The method of claim 22 further comprising transmitting instructions to the person to position the cellular telephone within audio range of the lock module sufficiently and transmitting audio signals between the base station and the lock module through the cellular telephone.

24. The method of claim 21 further comprising the act of operating the lock module with the data transmitted to the lock module by the cellular telephone from the base station.
